(19) United States
(12) Patent Application Publication
(10) Pub. No.: US 2011/0095084 A1
(43) Pub. Date: Apr. 28, 2011

(54) Personal financial terminal device

(75) Inventors: WeiCheng Tian, ShangHai (CN); Yi Dong, Shanghai (CN)

(73) Assignee: Onbest Technology Holding Limited

(21) Appl. No.: 12/589,438

(22) Filed: Oct. 23, 2009

(51) Int. Cl. G06Q 40/00

(52) U.S. Cl. 235/379

(57) ABSTRACT

A personal financial terminal device includes a core circuit module having a CPU and a data unit electrically connected to the CPU, a display module operatively connected to the core circuit module, and a protection arrangement for protecting the security data information store in the core circuit module. A swipe slot, an inserting slot, and a USB port are further provided at a peripheral edge of an outer casing, so that the terminal device of the present invention is able to obtain information stored in a magnetic strip card, smart card, or via connecting to an external device respectively. Therefore, the personal financial terminal device is able to integrate with most of the existing financial transaction networks or platforms to complete the individual business transactions.

### FIELD OF INVENTION

The present invention relates to a financial terminal device, and more particularly to a portable personal financial terminal device, which is able to be portably carried by an individual user to securely communicate with multiple financial transaction networks, so as to manage personal financial information.

### DESCRIPTION OF RELATED ARTS

Electronic money has been one of the main ways of money flow for transactions. For examples, online banking provides the user to complete financial transactions through internet via a personal online account; a buyer and a seller of the user may complete the payment via credit card through a POS machine of financial terminal device to communicate with bank and terminal user; the transactions may be completed via a third party providing a transaction platform on the internet, such as Paypal; the user may also complete a business transaction by a rechargeable smart card via purchasing from a card vending machine located at a predetermined public location.

In order to accomplish the electronic money flow for each of the financial transactions, such as transaction on credit or transaction for account through online banking, there are lot of electronic device are developed for being used as a financial terminal device to remotely and electronically communicate with the financial institutions, so as to complete the business transaction between two parties or person. For instances, electronic devices such as personal computer, cell phone, or portable credit card machine, which is used in those individual stores such as a restaurant, are playing an important role of electronic money flow in the electronic, computerization era. People are using the electronic devices for saving personal information or doing business transactions. More specifically, take a personal computer for example, password information of an email account are saved in the personal computer. A credit card machine communicating with the financial institutions through POS (point of sale/service) method, as another example, is widely used in most of the stores for the transaction among customers, stores, and a bank.

However, there are several main concerns of the existing electronic devices. Firstly, most of the financial terminal electronic devices, such as POS credit card terminals, only has a single function and can only communicate with single financial transaction network. Therefore, there is one only payment method can be conducted through the financial terminal device. In other words, there are no financial terminals which can provide a platform being compatible with most of the current financial network for completing the electronic money flow or transaction.

Accordingly, the information that inputted in the credit card machine for the transaction purpose may be illegally stolen by using any external forces and/or electronic devices to invade into the circuit board of the credit card machine so as to obtain the information saved in the memory unit of the circuit board. Though those electronic devices provide an easier and more convenience way of life style, how to protect those important personal information from being illegally obtained for any illegal purposes is a main concern.

Furthermore, most of the financial terminals locate at a predetermined location, such as ATM machines, and the card vending machines for recharging the value of the IC card used as electronic money, thereby causes the inconvenience of the user to complete the business or financial transactions.

Online banking is another payment platform. Online banking is based on internet and internet is not a secured medium. There is no a standard authorization system for online banking.

Mobile phone banking is also used in these days. But mobile phone banking can only perform small amount of transaction.

Accordingly, the present invention provides a portably personal financial terminal device for personal financial management, which enables the users to carry with them and hand hold the device for face-to-face business transactions, online banking, or other electronic money flow method without providing personal information to a third party, such as through cashier or let the retails or restaurants have a chance to stole the credit card information.

The software of the financial terminal device has the compatibility of most of the transaction networks, so that the user is able to make a transaction to another person or parties through variety of methods via the personal financial terminal device such as sliding credit card, debit card, IC card, and key in confirmation or passwords.

In order to prevent the financial terminal device being stolen to obtain the private data stored in the terminal device, the personal financial terminal device also provides a securely data protecting system including a securely data protecting arrangement of hardware and a securely data defense software, so that when the device is broke to get any information from a data unit of the terminal device, a detective circuit of the device is automatically activated to erase the information saved in the data unit.

Therefore, the present invention provides a portably personal financial terminal device, so that the user is able to conveniently doing the financial transaction by the individually portable terminal device, which is able to be hand held for financial business transaction as a mobile electronic bank. The software and hardware designed a sturdy protection way to prevent the privately personal information being stolen. The financial terminal device also provides a platform which is compatible with most of the financial transaction networks, so that the user is able to complete the transactions via variety way, such as connecting the financial terminal device to the PC via USB to make an online transfer. The present invention also allows making transaction person-to-person without through the third party, so that the electronic money is able to be concurrently transferred from one bank account to another.

### SUMMARY OF THE PRESENT INVENTION

A main object of the present invention is to provide a portably personal financial terminal device for managing personal financials, which guarantees the safety of data unit for storing the encrypted personal financial information, and integrates most of the financial transaction networks, so as to provide a platform to compatibly and electronically complete the financial transactions without through a third party.

Accordingly, in order to accomplish the object, the present invention provides a personal financial terminal device comprises a core circuit module for saving data information, a display module operatively connecting to the core circuit module. The core circuit module comprises a CPU and a data unit controllably operated by the CPU for accessing the data information.

An portable housing is further provided to securely enclose the core circuit module, display module, the protection element, and the detective circuit, such that the outer casing also provides another protection of the data unit of the core circuit module.

The personal financial terminal device further has a swipe slot, and a inserting slot provided at one of two side edges of the housing respectively, wherein a reading head electrically linked to the core circuit module is extended to a through opening within the swipe slot, such that the personal financial is able to slidably and electrically contact the reading head with a card for reading information stored therewithin. Thus, the personal financial terminal device satisfies usage standard credit card company, and support the magnetic credit card standard and international IC credit card standard, so as to satisfy the demand of sales purpose in most of the countries, such as North America and Europe.

Therefore, the personal financial terminal device can be used for a card-to-card, account-to-account, card-to-account, or account-to-card payment types, so as to create a fast track for banks and financial entities.

In addition, the present invention also provides a plurality of standard references of the special tests and safety checks of the personal financial terminal device. The personal financial terminal device guarantees the safety and quality of the personal financial terminal device.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a personal financial terminal device according to a preferred embodiment of the present invention.

FIG. 2 is block diagram of the personal financial terminal device according to the above preferred embodiment of the present invention.

FIG. 3 is a plurality of parameters of electromagnetic compatibility of the personal financial terminal device according to the above preferred embodiment of the present invention.

FIG. 4 is a plurality of parameters of temperature cycle test of the personal financial terminal device according to the above preferred embodiment of the present invention.

FIG. 5 is a plurality of parameters of interchanging temperature at working status test of the personal financial terminal device according to the above preferred embodiment of the present invention.

FIG. 6 is a plurality of parameters of constant humidity and temperature at storing info status test and temperature of connection wires test of the personal financial terminal device according to the above preferred embodiment of the present invention.

FIG. 7 is a plurality of parameters of spraying and dust test of the personal financial terminal device according to the above preferred embodiment of the present invention.

FIG. 8 is a plurality of parameters of mechanical test of the personal financial terminal device according to the above preferred embodiment of the present invention.

FIG. 9 is a plurality of parameters of electronic security standard test of the personal financial terminal device according to the above preferred embodiment of the present invention.

FIG. 10 is a plurality of parameters of heating test of the personal financial terminal device according to the above preferred embodiment of the present invention.

FIG. 11 is a plurality of parameters of overload test of the personal financial terminal device according to the above preferred embodiment of the present invention.

FIG. 12 is a plurality of parameters of environmental test of the personal financial terminal device according to the above preferred embodiment of the present invention.

### DETAILED DESCRIPTION OF THE PREFERRED EMBODIMENT

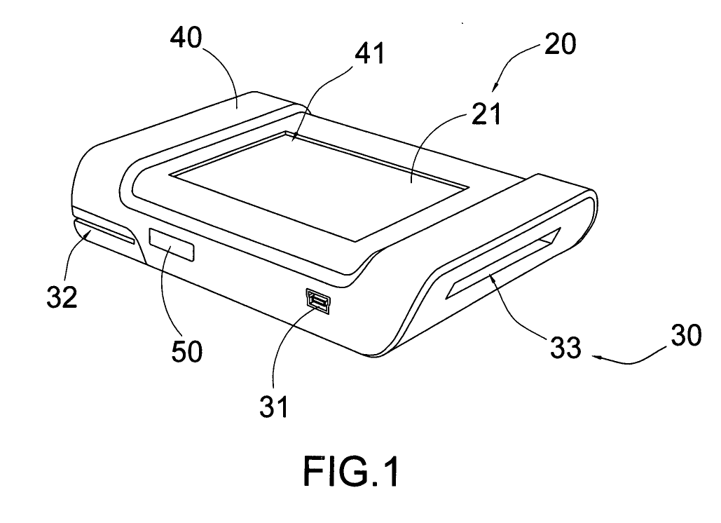

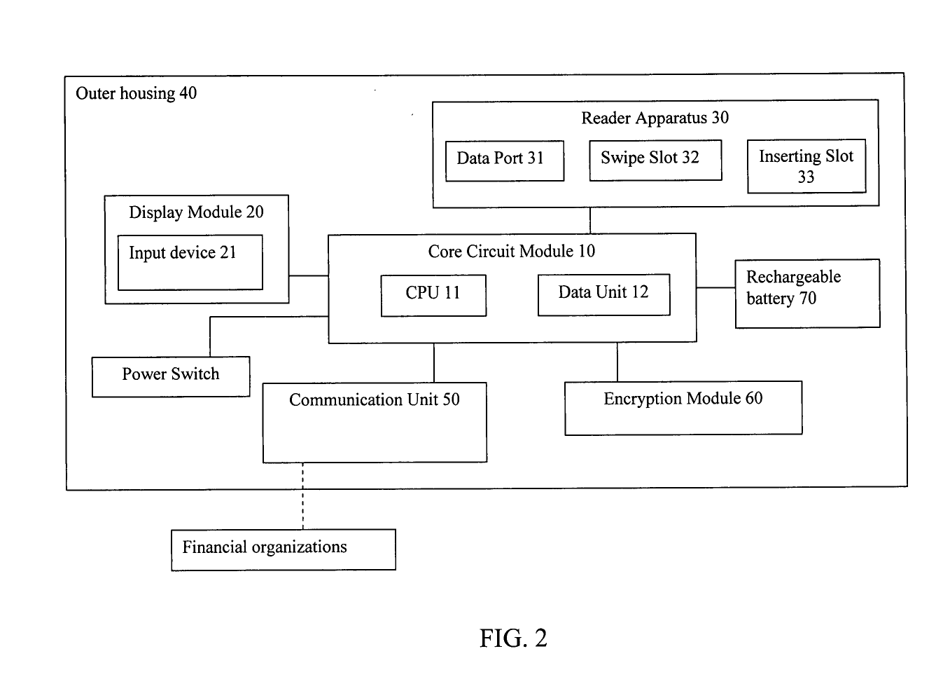

Referring to FIGS. 1 and 2 of the drawings, a personal financial terminal device according to a preferred embodiment of the present invention is illustrated, which comprises a core circuit module 10 for storing data information, and a display module 20 electrically linking to the core circuit module 10 for communicatively displaying related data information. Accordingly, the core circuit module 10 comprises a CPU 11 and a data unit 12 controllably operated by the CPU 11 for accessing the data information stored therewithin.

The personal financial terminal device further comprises a portable housing 40 having a receiving cavity to define a top window 41, wherein the display module 20 electrically linked to the CPU 11 of the core circuit module 10 is securely mounted at the top window 41, so as to securely conceal the receiving cavity for protection of the core circuit module 10 enclosed within the portable housing 40. A rechargeable battery 70 is received in the portable housing 40 to electrically link with the core circuit module 10.

The display module 20 further provides a touch screen integrally formed with the display module as an input device 21 for inputting personal data information, such that an instruction and requirement of providing password may showed on the display module 20 and the individuals may input a personal password via the touch screen of input device 21 to access the data stored in the data unit 12 in an authorized manner. As will be appreciated that the randomly digital input device 21 for inputting personal information without a keyboard layout to electrically connect to the CPU 11 efficiently minimize the risk of being hacked via the keyboard circuit.

As mentioned above, a communication unit 50 is further provided in the receiving cavity of the portably housing 40 as one of the internal components to electrically link to the CPU 11 of the core circuit module 10, so that the portable personal financial terminal device is able to wirelessly connect with a plurality of the financial organizations for proceeding financial transactions.

The personal financial terminal device further has an encrypting unit 60 electrically linking to the CPU 11 for encryption of data information stored in the core circuit module 10, so as to ensure the security of transmitting the data wirelessly or with wire via a communication network in an encrypted manner.

In order to incorporate the personal financial terminal device with other electronic device or electronic money flow method, the personal financial terminal device further comprises a reader apparatus 30, which comprises a data port 31 for detachably connecting an external electronic device via a data cable, a swipe slot 32 for slidably swiping a magnetic strip card, and an inserting slot 33 for inserting a smart card, such as IC card, provided at a peripheral edge of the portable housing 40, so that the personal financial terminal device is able to obtain the financial information via variety of methods. The data port 31 provided at a peripheral edge of the portable housing 40 is adapted for detachably connecting to the external electronic device, such as PC, notebook, or other device or networks for connecting to a financial institute via USB cable.

More specifically, the data port 31 is preferably provided at one of a front peripheral face and a rear peripheral face of the portable housing 40 to operatively communicate with an electronic device via the data cable. The data port 31 may enable the personal financial terminal device to wirely connect to an external device or the communication network, such as telephone line. The data port 31 is embodied as a USB port 311 for connecting with most of the electronic device, such as cell phone, PC, or notebook, so as to incorporate with individual devices for integrally managing personal financial data.

The swipe slot 32 is transversely formed at one of the side peripheral faces of the portable housing 40 for the magnetic strip card being conveniently and slidably swiped therethrough, wherein a reading head is provided within the swipe slot 32 to electrically connect to the core circuit module 10 and to physically contact with the magnetic strip of the magnetic strip card by swiping pass the swipe slot 32, such that the information stored in the magnetic strip is able to be read via the personal financial terminal device to proceed the financial transactions. Accordingly, the swipe slot 32 has two open ends formed at front and rear peripheral faces of the portable housing 40 respectively, such that the magnetic strip card is able to conveniently swiped through one to the other open ends of the swipe slot 32 at the side peripheral face via one hand of the user while the other hand of the user is holding the body of portable housing 40 firmly.

The inserting slot 33 is preferably provided at another opposed side peripheral face of the portable housing 40 for the smart card inserted thereinto to obtain the information stored in the smart card. Therefore, the reader apparatus 30 provides a multiple methods to read the personal financial information via combining multi-functions in one portably personal financial terminal device.

Accordingly, a transaction platform is further provided to communicatively linking between personal financial accounts and financial organizations via variety of financial system, such as POS or internet, through the communication unit 50 and/or the reader apparatus 30. The transaction platform is displayed on the display module 20 for being controllably selected by the touch screen of the input device 21, so that the individual is able to portably carry the personal financial terminal device to proceed with the business transactions without giving personal information to a third party or the sellers.

Therefore, the personal financial terminal device enables the individuals to progress the business transactions directly with the financial organization, such as the banks, such that there is no need to type in personal account information of each of the financial organizations on line or swipe personal financial card, i.e. credit card, debit card, or smart card via the sellers POS credit card machine used in most of retail stores, which might obtain personal financial cards data through the third party's credit card machine.

The encrypting unit 60 ensures the sensitive data information stored in the core circuit module 10 is encrypted, so that while the transmitting of the financial data information between the personal financial terminal device and the financial organization, the data is securely encrypted to prevent an unauthorized user hacked to obtain the data information. The hardware of the portable housing 40 and the software installed in the personal financial terminal device provide a security system, so that when the personal financial terminal device is broken to tempt to illegally obtain the stored information within the data unit 12, a detective circuit is activated to block or automatically erase the sensitive data information. The self destroy defense system provides further protection to ensure the safety of the sensitive data information saved in the personal financial terminal device.

In addition, the personal financial terminal device of the present invention meet the requirement of tamper detection mechanisms, which cause the personal financial terminal device to become immediately inoperable and results in the automatic and immediate erasure of any secret information which may be stored in the core circuit module 10. Accordingly, the CPU 11 of the personal financial terminal device adapts a PCI certified CPU and safety standard to meet the requirement of the tamper detection mechanisms.

The independent security mechanism is another requirement, wherein a failure of a single security mechanism does not compromise a PIN Entry Device (PED) of the personal financial terminal device security. Protection against a threat is based on a combination of at least two or more independent security mechanisms. Therefore, the present invention provides two or more independent protection mechanisms.

Another requirement is responding to internal access. If the personal financial terminal device permits access to internal area, such as for service or maintenance, then it is not possible using this access area to insert a pin disclosing bug. Immediate access to sensitive information such as PIN or cryptographic data is either prevented by further means, such as by enclosing components with sensitive data into tamper resistant/responsive enclosures, or it has a mechanism so that such access causes the immediate erasure of sensitive data. Therefore, the present invention also adapts PCI certified CPU 11 and related safety requirements to achieve the above requirement.

The robustness under changing environment and operational conditions must not compromise the security of the PED. In other words, the security of the personal financial terminal device is not compromised by altering environmental conditions or operational conditions.

The present invention also adapts the PCI certified CPU to achieve the requirement of protection of sensitive functions or information. The sensitive functions or information are only used in the protected area(s) of the PED. Sensitive information and function dealing with sensitive information are protected from modification.

A buzzer is provided in the personal financial terminal device to meet the requirement of audible tones during PIN entry. If the pin entry is accompanied by audible tones, then the tone for each entered PIN digit is indistinguishable from the tone for any other entered pin digit.

The irregular voice prompt and digital keyboard of the personal financial terminal device satisfies the EMC testing mechanical standard of monitoring during PIN entry. There is no feasible way to determine any entered and internally transmitted PIN digit by monitoring sound, electro-magnetic emissions, power consumption or any other external characteristic available for monitoring, even with the cooperation of the terminal operator or sales clerk.

The determining keys analysis to determine any PIN-security-related cryptographic key resident in the PED or ICC reader is by penetration of the PED or ICC reader and/or by monitoring emanations from the PED or ICC reader (including power fluctuations), which requires an attach potential of at least 35 identification and initial exploitation.

The data lines of the personal financial terminal device is located at a position within the network; the random keyboard design, and the security data storing area being supplied power continuously of the personal financial terminal device achieve the requirement of Prompts under control of the cryptographic unit and cryptographically based controls. The prompts are stored outside the cryptographic unit, cryptographic mechanisms must exist to ensure the authenticity and the proper use of the prompts and that modification of the prompts or improper use of the prompts are prevented. For active display devices, cryptographically based controls are utilized to control the PED display and PED usage such that it is infeasible for an entity not possessing the unlocking mechanism to alter the display and to allow the output of unencrypted PIN data from the PED. The controls provide for unique accountability and utilize key sizes appropriate for the algorithm(s) in question. Key management techniques and other control mechanisms are defined and include appropriate application of the principles of dual control and split knowledge.

The random keyboard and adjustable brightness design of the present invention meets the requirement of visual observation deterrents. The PED provides a means to deter the visual observation of PIN values as they are being entered by the cardholder.

The present invention also has a unique enclosure. The design of the PED or ICC reader is such that it is not practical to construct a duplicate PED or ICC reader from commercially available components.

The personal financial terminal device also provides related security magnetic stripe head reading and its related components to achieve the requirements of magnetic strip reader. It is not feasible to penetrate the PED to make any additions, substitutions, or modifications to the Magnetic strip Read head and associated hardware or software, in order to determine or modify magnetic strip track data.

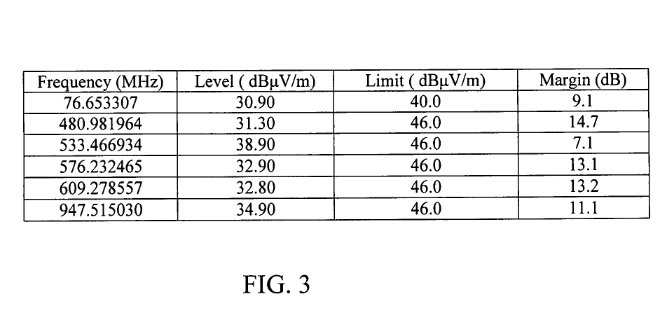

Referring to FIGS. 3 to 11, a plurality of requirements and parameters of test references of the personal financial terminal device is illustrated, wherein the test results show the evidence of the personal financial terminal device passed the special and standard requests or tests, so that the personal financial terminal device is able to provide securely personal financial management.

Referring to FIG. 3 to of the drawings, a plurality of parameters of tests for the personal financial device are illustrated. As shown in FIG. 3, the field strength of the personal financial terminal device is between 15 and 39 dBμV/m when the frequency range is between 30 MHz to 1 GHz. The limit of the field strength is 46.0 dBμV/m. Therefore, the critical radiation value of the personal financial terminal device of the present invention is relatively low to minimize the radiation of the present invention being harmful to human health. In particularly, the electrical configuration of the PCB and the configuration of the internal components of the present invention are well organized to prevent any interference and to minimize the radiation of the present invention.

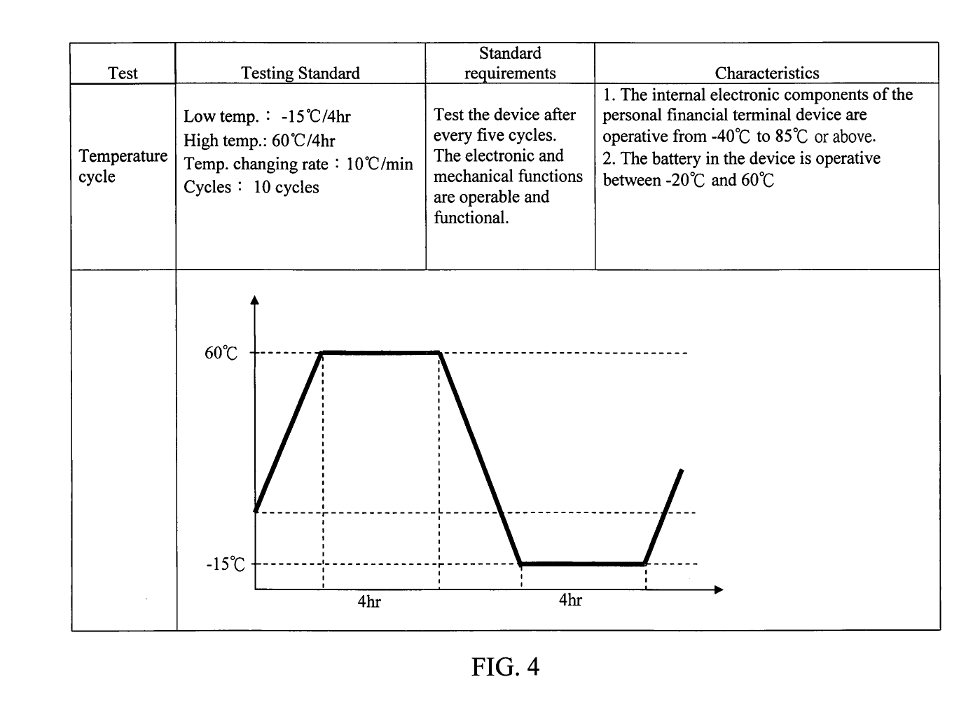

Referring to FIGS. 4 to 8 of the drawings, the parameters of reliability standard are illustrated, wherein the reliability parameters standard comprises environment temperature testing, chemical testing, and mechanical testing. The environment temperature testing comprises temperature cycle, interchanging temperature at working status of the personal financial terminal device at high humidity situation, constant humidity and temperature at storing info status of the personal financial terminal device, and temperature of connection wires testing.

The personal financial terminal device of the present invention is operative under a harsh temperature environment. The personal financial terminal device is tested under a temperature environmental test as shown in FIG. 4. Accordingly, the temperature environmental test includes ten temperature cycles of temperature change. At each temperature cycle, the present invention is tested under a low temperature at −15° C. for 4 hours and under a high temperature at 60° C. for 4 hours subsequently, wherein the temperature change rate is 10° C./min between the low and high temperature settings. The present invention is tested for every five temperature cycles until ten temperature cycles are completed. Accordingly, the electronic components of the present invention are operative between −40° C. and +85° C., and the battery 70 of the present invention is operative between −20° C. and +60° C. In other words, the present invention is operative between −15° C. and +60° C. It is worth mentioning that the cooling effect of the present invention is relatively good by configuring the PCB of the present invention in an overlapping manner to ensure the heat being dispersed properly.

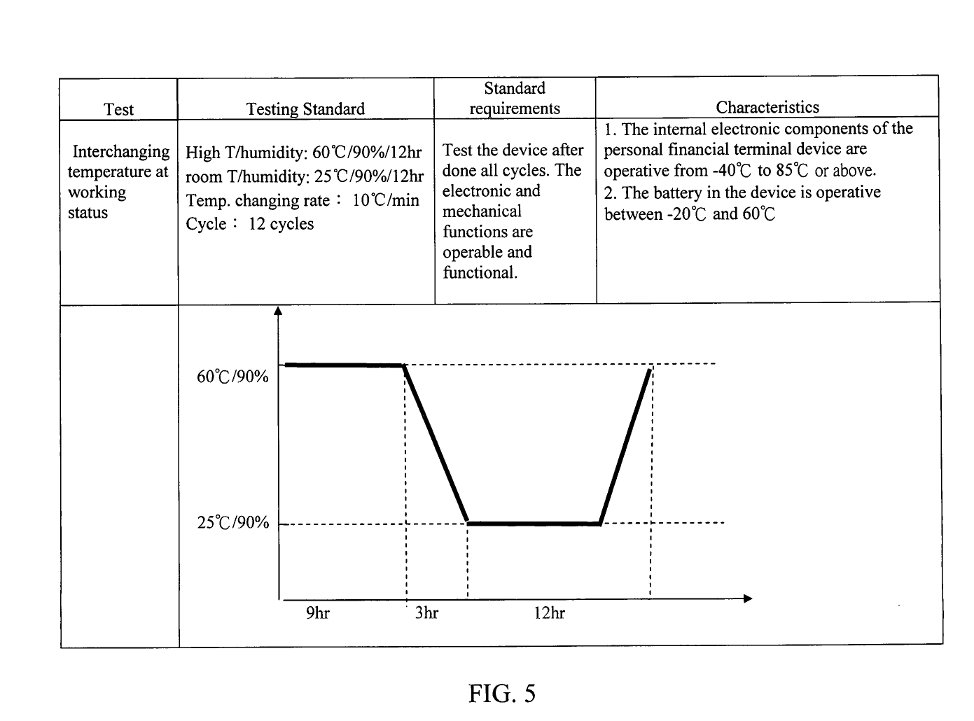

The personal financial terminal device of the present invention is operative under a humidity-temperature test as shown in FIG. 5. The humidity-temperature test includes 12 humidity-temperature cycles in responsive to the temperature change at constant humidity. At each humidity-temperature cycle, the present invention is tested under a high temperature at 60° C. and 90% humidity for 12 hours and under a room temperature at 25° C. and 90% humidity for 12 hours subsequently, wherein the temperature change rate is 10° C./min. The present invention is operative after 12 humidity-temperature cycles are completed. The humidity-temperature test shows that the present invention incorporates with a sealing arrangement to protect the internal electronic components.

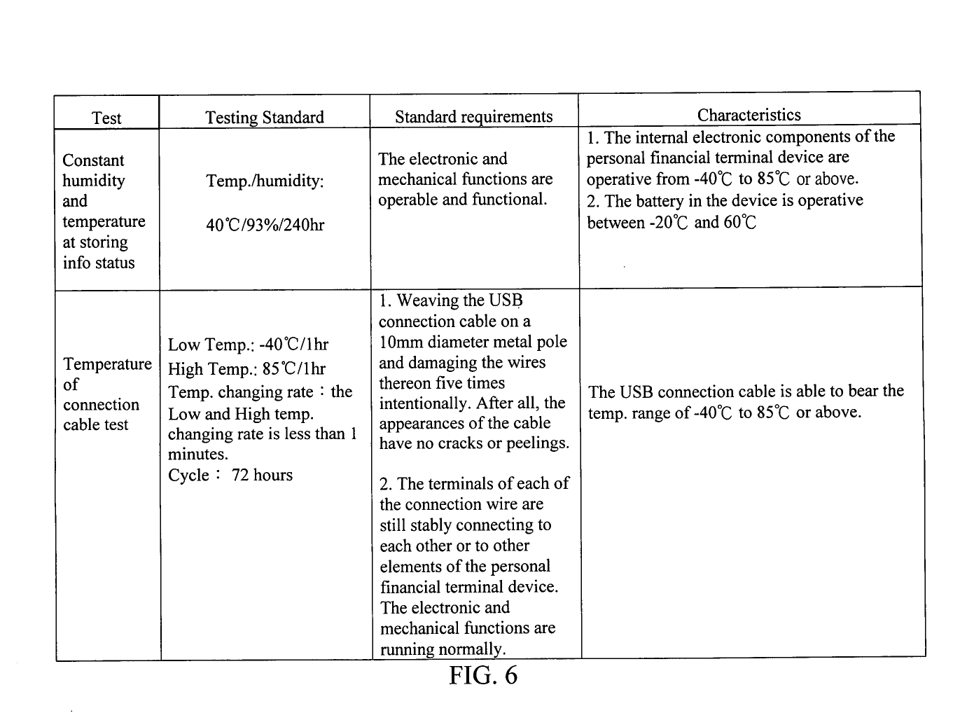

The personal financial terminal device of the present invention is operative under a humidity test as shown in FIG. 6. The condition of the humidity test is configured at 40° C. and 93% humidity for 240 hours. After the test, the electronic and mechanical functions of the personal financial terminal device can be normally run after 240 hours. The humidity test further proves that the sealing effect of the present invention to protect the internal electronic components.

The personal financial terminal device of the present invention is operative under a wiring-temperature test as shown in FIG. 6. The connection cable, i.e. USB cable, is connected to the present invention and is weaving at a metal rod with a 10 mm diameter to intentionally damage the connection cable. The wiring-temperature test is that the present invention is tested under a low temperature at −40° C. for one hour and under a high temperature at 85° C. for one hour subsequently, wherein the interval between the low and high temperature is no longer than one minute. Thus, the test is completed by repeating the temperature cycle for 72 hours. As a result, the present invention is operative when the connection cable is connected thereto. No cracks happened after bending the connection cable. After electrically connecting to an equipment to incorporate with the personal financial terminal device, the electronic and mechanical functions are running normally. Therefore, the connection cable is operative between at −40° C. and 85° C.

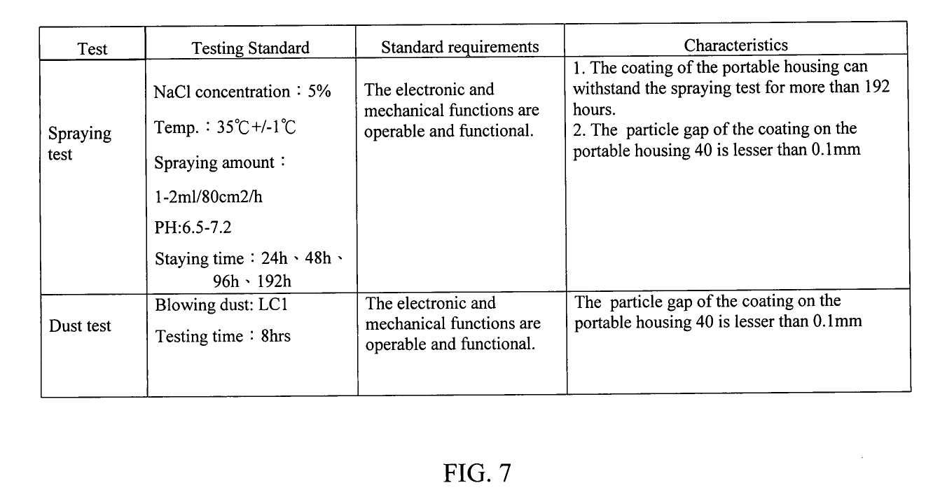

As shown in FIG. 7 of the drawings, the personal financial terminal device of the present invention is operative under a chemical test which includes a spraying test and dust test. The spraying reagent contains 5% NaCl and has the pH between 6.5 and 7.2. The spraying test temperature is at 35±1° C., the spraying amount is 1 to 2 ml at a spraying rate of 80 cm² per hour, and the spraying reagent staying on the personal financial terminal device is 24 hours, 48 hours, 96 hours, and 192 hours respectively. After the spraying test, the outer appearance, electronic, and mechanical function of the personal financial terminal device are normal. The coating on the portable housing 40 of the present invention has no damages, cracks, deformation or serious corrosion of the personal financial terminal device. Accordingly, the particle gap of the coating on the portable housing 40 is lesser than 0.1 mm to provide a protection effect for the casing so as to prevent the spraying reagent entering into the interior of the casing. In other words, the coating is applied to the portable housing 40 to improve the corrosion resistance, wear resistance and scratch resistance of the present invention.

The personal financial terminal device of the present invention is operative under the dust test by continuously blowing the dust on the present invention for 8 hours. Since the particle gap of the coating on the portable housing 40 is lesser than 0.1 mm, the portable housing 40 can prevent any dust entering into the interior of the portable housing 40. As a result, the chemical test shows the durability of the present invention for sealing the internal electronic components and for preventing any corrosion for the casing, so as to prolong the service life span of the present invention.

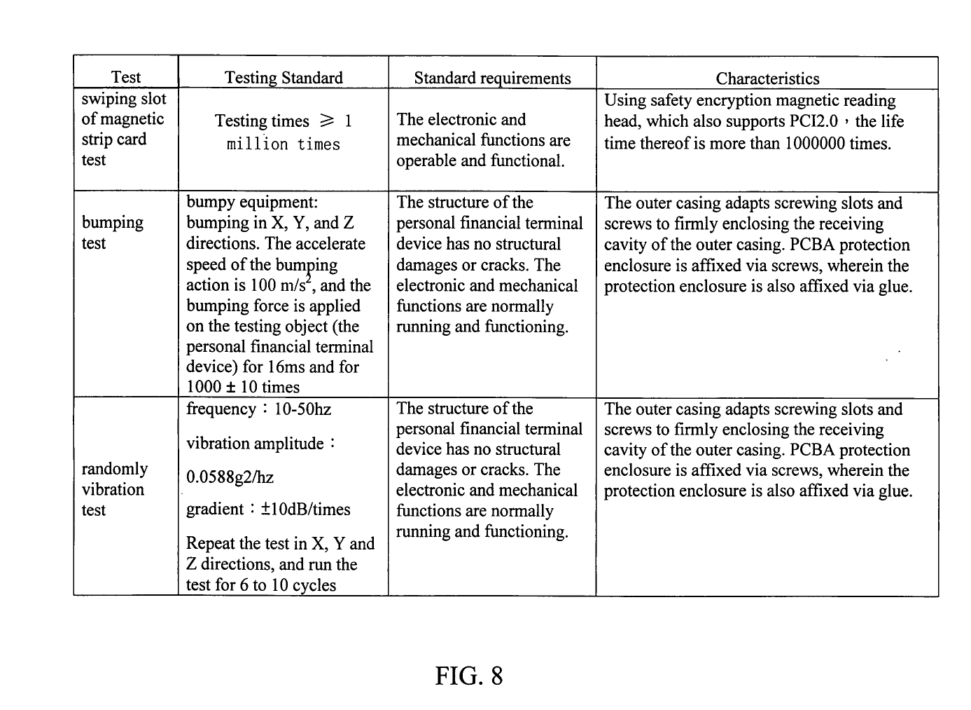

The personal financial terminal device of the present invention is operative under a mechanical test as shown in FIG. 8, wherein the mechanical test includes a swipe slot test, a bumping test, and a randomly vibration test.

Accordingly, the swipe slot 32 of the personal financial terminal device is being slidably swiped via a magnetic strip card more than 1,000,000 times. After 1,000,000 times of swiping, the electronic and mechanical functions are running normally, and the responding time of the personal financial terminal device is functioning.

The bumping test of the mechanical test is completed via the bumpy equipment, wherein the personal financial terminal device is bumped in 3 dimensional directions, i.e. along the X, Y, and Z axis. The accelerate speed of the bumping action is 100 m/s², and the bumping force is applied on the testing object (the personal financial terminal device) for 16 ms and for 1000±10 times. The structure of the personal financial terminal device has no structural damages or cracks. The electronic and mechanical functions are normally running and functioning.

The present invention is tested through the randomly vibration test of the mechanical test under 10-50 hz of frequency, 0.588 g2/hz of vibration amplitude, and ±10 dB/times of gradient for two hours. Repeat the test in X, Y and Z directions respectively to complete one testing cycle, and run the test for 6 to 10 cycles. After the test, the structure of the personal financial terminal device has no structural damages or cracks. The electronic and mechanical functions are normally running and functioning.

Accordingly, the mechanical test shows that the durability of the present invention, wherein the swipe slot 32 can be utilized for more than 1000000 times of card swiping. The outer casing of the present invention can seal and encase the internal electronic components, such as PCB. In particularly, the PBB is further protected within a protection enclosure within the outer casing for preventing any external impact applying to the present invention so as to avoid any damage of the present invention.

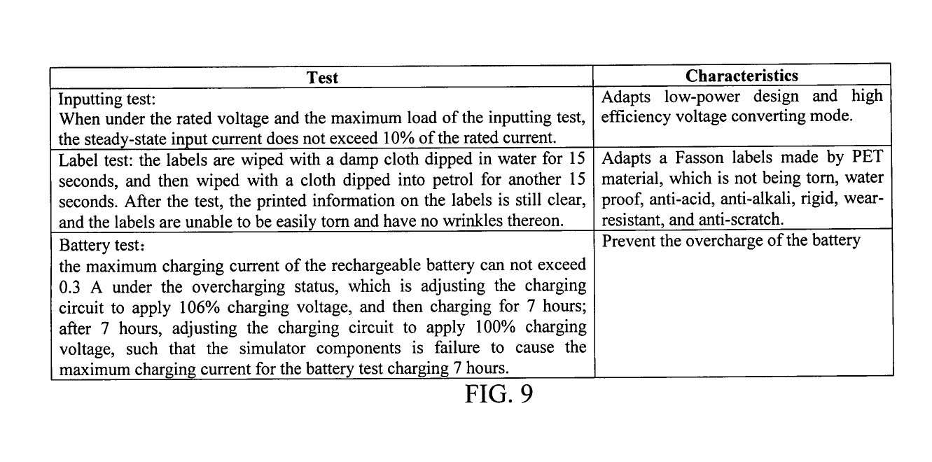

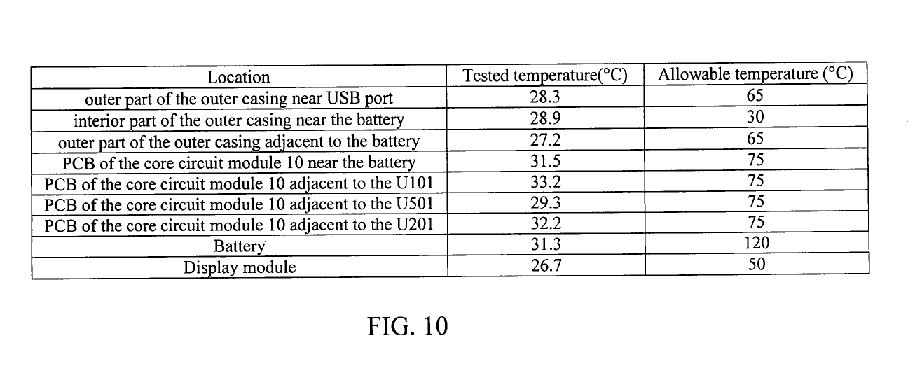

Referring to FIGS. 9 and 10 of the drawings, the parameters of electronic security standard are illustrated, wherein the electronic security standard comprises an inputting test, label test, battery test, heating test, and overload test. When under the rated voltage and the maximum load of the inputting test, the steady-state input current does not exceed 10% of the rated current. In order to achieve the standard requirement, the personal financial terminal device of the present invention adapts low-power design and high efficiency voltage converting mode.

The labels attached on the personal financial terminal device is preferably a Fasson label, which is made by PET material having the characteristics of is not being torn, water proof, anti-acid, anti-alkali, rigid, wear-resistant, and anti-scratch. Therefore, in the label test, the labels of the personal financial terminal device are wiped with a damp cloth dipped in water for 15 seconds, and then wiped with a cloth dipped into petrol for another 15 seconds. After the label test, the printed information on the labels of the personal financial terminal device are still clear, and the labels itself is unable to be easily torn down and has no wrinkles thereon.

The battery test standard requires that the maximum charging current of the rechargeable battery 70 can not exceed 0.3 A (Ampere) under the overcharging status. The overcharging status includes the following steps: adjusting the charging circuit to apply 106% charging voltage for charging 7 hours. After 7 hours, the charging circuit is re-adjusted to apply 100% charging voltage to the rechargeable battery 70. The battery test simulates the failure of charging of the rechargeable battery 70 for test charging 7 hours.

The heating test is conducted at 25° C. room temperature at steady working status of the personal financial terminal device, as shown in FIG. 10, wherein the temperature of each of the parts of the personal financial terminal device should not exceed each of the following temperatures respectively: an outer part of the outer casing 40 adjacent to the USB port 41 is 65° C.; an interior part of the outer casing 40 adjacent to the battery 70 is 30° C.; the outer part of the outer casing 40 adjacent to the battery 70 is 65° C.; PCB of the core circuit module 10 adjacent to the battery 70 is 75° C.; the PCB of the core circuit module 10 adjacent to the U101 is 75° C.; the PCB of the core circuit module 10 adjacent to the U501 is 75° C.; the PCB of the core circuit module 10 adjacent to the U201 is 75° C.; the battery is 120° C.; and the screen of the display module 20 is 50° C.

The result of the heating test is that the outer part of the outer casing 40 adjacent to the USB port 41 is 28.3° C.; the interior part of the outer casing 40 adjacent to the battery 70 is 28.9° C.; the outer part of the outer casing 40 adjacent to the battery 70 is 27.2° C.; PCB of the core circuit module 10 adjacent to the battery 70 is 31.5° C.; the PCB of the core circuit module 10 adjacent to the U101 is 33.2° C.; the PCB of the core circuit module 10 adjacent to the U501 is 29.3° C.; the PCB of the core circuit module 10 adjacent to the U201 is 32.2° C.; the battery 70 is 31.3° C.; and the screen of the display module 20 is 26.7° C. The heating test shows that the present invention has good heat dispersing effect to prevent the overheating of the personal financial terminal device, so as to prolong the service life span of the personal financial terminal device. Accordingly, the PCB has a circuit overlapping structure to effectively disperse the heat generated therefrom. In generally, the present invention has an operative temperature not higher than 33.2° C. at room temperature of 25° C.

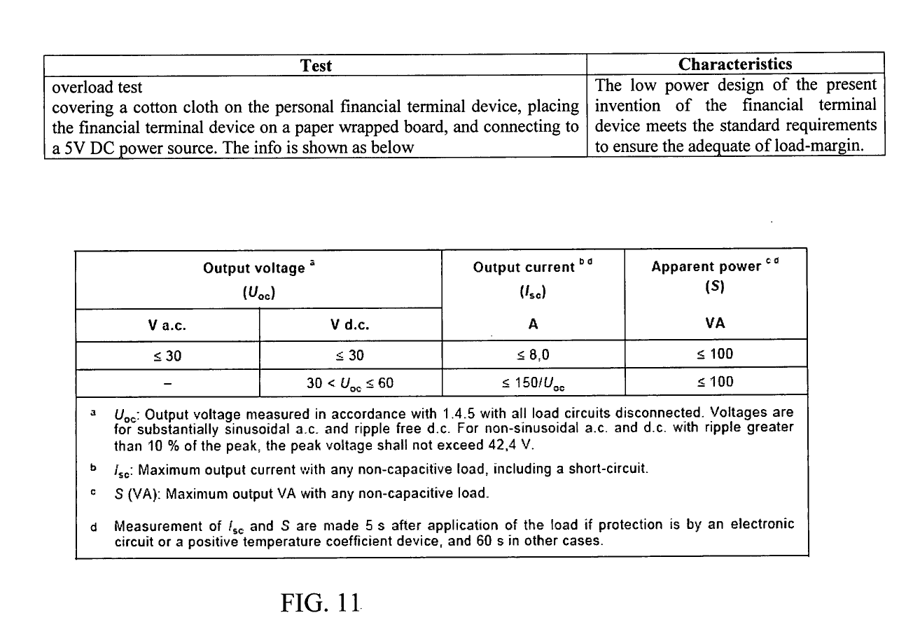

The overload test is conducted via covering a cotton cloth on the personal financial terminal device, placing the financial terminal device on a paper wrapped board, and connecting to a 5V DC power source. The potential voltage test points are adjacent to the connection ports of the connector. Under the overload test condition, the low power design of the present invention of the financial terminal device ensures the adequate of load-margin, as shown in FIG. 11. Accordingly, since the present invention is a low powered consumption device, the heat generated at the internal electronic components will be correspondingly reduced, so as to ensure the sensitive electronic components being operated normally and to ensure the present invention being used safely.

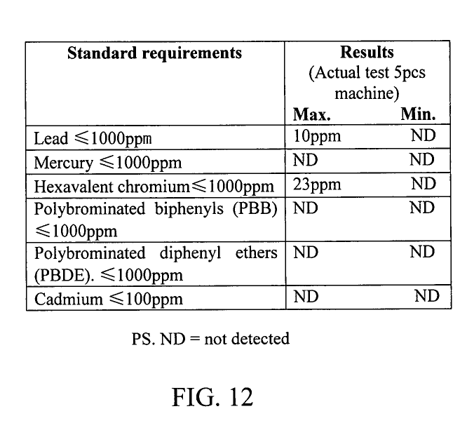

Referring to FIG. 12 of the drawings, all the electronic components in the personal financial terminal device and the packing material are environmental friendly. The personal financial terminal device and its material also meet the environmental parameters, wherein the compositions of lead, mercury, hexavalent chromium, polybrominated biphenyls (PBB), polybrominated diphenyl ethers (PBDE) and cadmium of financial terminal device must be less than 1000 ppm, and the contains of cadmium of financial terminal device is less than 100 ppm. The results of the testing are that the highest limit of lead is 10 ppm, and the highest limit of hexavalent chromium is 23 ppm. In addition, mercury, polybrominated biphenyls (PBB), polybrominated diphenyl ethers (PBDE), and cadmium cannot be detected throughout the test. Therefore, the present invention is safe for human use and to inflict minimal or no harm on the environment.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A personal financial terminal device for a user to complete a financial transaction, comprising:
a portable housing defining a top window;
a core circuit module receiving in said portable housing for storing personal financial information to communicate with financial organizations to precede the financial transaction;
a display module provided on said portable housing at said top window thereof;
an input device, which is operatively linked to said core circuit module, provided at a periphery of said portable housing for the inputting the personal information into said core circuit module; and
a communication unit operatively linked to said core circuit module for wirelessly communicating with the financial organizations in a securely manner through a wireless communication network.

2. The personal financial terminal device, as recited in claim 1, further comprising an encrypting unit operatively linked to said core circuit module to encrypt the personal information being stored in said core circuit module.

3. The personal financial terminal device, as recited in claim 1, wherein said input device comprises a swipe slot transversely formed at one side peripheral face of said portable housing for a magnetic strip card being slidably swiped therethrough and an inserting slot provided at another opposed side peripheral face of said portable housing for a smart card slidably inserting thereinto.

4. The personal financial terminal device, as recited in claim 3, wherein said swipe slot has two open ends formed at front and rear peripheral faces of said portable housing respectively.

5. The personal financial terminal device, as recited in claim 4, which is operative when the magnetic strip card is being slidably swiped at said swipe slot for more than 1,000,000 times.

6. The personal financial terminal device, as recited in claim 3, wherein said input device further comprises a data port provided at one of a front peripheral face and a rear peripheral face of said portable housing for operatively communicating with an electronic device via a data cable.

7. The personal financial terminal device, as recited in claim 6, wherein said data port is a USB port.

8. The personal financial terminal device, as recited in claim 1, which has an operation temperature range between −15° C. and 60° C.

9. The personal financial terminal device, as recited in claim 1, which is operative under an environment temperature change between a low temperature of −15° C. and a high temperature of 60° C. with a temperature change rate of 10° C./min.

10. The personal financial terminal device, as recited in claim 1, which has a field strength between 15 and 39 dBμV/m when a frequency range of the personal financial terminal device is between 30 MHz to 1 GHz.

11. The personal financial terminal device, as recited in claim 1, which is operative at a temperature between 25° C. and 60° C. at a humidity of 90%.

12. The personal financial terminal device, as recited in claim 1, wherein said core circuit module is operative under an environment condition at 40° C. and 93% humidity.

13. The personal financial terminal device, as recited in claim 1, wherein said portable housing has a coating applied thereon, wherein a particle gap of said coating is lesser than 0.1 mm.

14. The personal financial terminal device, as recited in claim 1, which is operative and withstood an accelerate speed of a bumping action as 100 m/s² and a bumping force applied on the personal financial terminal device for 16 ms and for 1000±10 times.

15. The personal financial terminal device, as recited in claim 1, which is operative and withstood a vibration with the condition of 10-50 hz of frequency, 0.588 g2/hz of vibration amplitude, and ±10 dB/times of gradient for two hours.

16. The personal financial terminal device, as recited in claim 1, wherein said core circuit module has an operating temperature range between −40° C. and 85° C.

17. The personal financial terminal device, as recited in claim 1, further comprising a rechargeable battery received in said portable housing to electrically link with said core circuit module, wherein said rechargeable battery has an operating temperature range between −20° C. and 60° C.

18. The personal financial terminal device, as recited in claim 17, wherein said rechargeable battery has a maximum charging current not exceeding 0.3 ampere under an overcharging status.

19. The personal financial terminal device, as recited in claim 1, which has an operative temperature not higher than 33.2° C. at room temperature of 25° C.

20. The personal financial terminal device, as recited in claim 1, which has environmental parameters that lead has the highest limit of 10 ppm, hexavalent chromium has the highest limit of 23 ppm, and mercury, polybrominated biphenyls (PBB), polybrominated diphenyl ethers (PBDE), and cadmium cannot be detected.
